(19) United States
(12) Patent Application Publication
(10) Pub. No.: US 2006/0134270 A1
(43) Pub. Date: Jun. 22, 2006

(54) Baked rye product

(76) Inventors: Renate Kunze, Potsdam (DE); Stephan Rauer, Ziegenhalz (DE); Guenter Zehle, Bergholz-Rehbruecke (DE)

Correspondence Address: LAW OFFICES OF KARL HORMANN, 86 SPARKS STREET, CAMBRIDGE, MA, 02138, US

(21) Appl. No.: 10/542,180

(22) PCT Filed: Jan. 13, 2004
(86) PCT No.: PCT/DE04/00056

§ 371 Date: Dec. 19, 2005

(30) Foreign Application Priority Data
Jan. 14, 2003 (DE) 103 01 724.0

(51) Int. Cl. A21D 13/00

(52) U.S. Cl. 426/94

(57) ABSTRACT

The invention relates to a baked rye product comprising at least 50 percent by weight of ground rye product, the percentage being in relation to the ground wheat products. Said baked rye product is obtained by adding exogenous yeasts to the dough and/or letting the dough mature for at least 12 hours at 20° C. (ambient conditions) prior to baking in order to activate the native flour enzymes. No sourdough and no dough acidifiers are added, the rye dough having a pH value of more than 4.7. Fat is added to said dough at a quantity of at least 0.5 percent relative to the ground wheat product.

The invention relates to a baked rye product with a mass proportion of ground grain products at least 50% of which is a groung rye product.

Even though in terms of nutrition physiology, price and a market-effective freshness preservation baked goods based upon ground rye are more advantageous than ground wheat products, many attempts have hitherto failed to market baked rye products and especially rye bread processes and the equipment required for their production, in other territories outside of central, northern and eastern Europe.

As regards nutrition physiology this is a disadvantageous development since for human nutrition rye constitutes a valuable cereal. Rye contains large quantities of roughage or soluble roughage. The major components in terms of roughage or non-starch-polysaccharides (NSP) are pentosanes and arabinoxylanes about one third of which are soluble. Other names for pentosanes are levulose or mucilaginous glucose. They are sweetish somewhat viscous substances which when starch is lixiviated from flour are left in the screen. Nowadays thy are considered to be roughage and have a very high water-binding capacity. Pentosanes contribute significantly to preserving the freshness of baked rye products and in particular of rye bread. Chemically they are part of the polysaccharides and mainly consist of arabinoxylanes. The insoluble pentosanes swell very significantly. They significantly determine the dough characteristics of rye dough. Pentosanes decisively contribute to the moistness of the crumbs.

However, rye starch gelatinates at markedly lower temperatures than wheat starch and thus is easily affected for the enzymatic decomposition by amylase. The temperature optimum of amylases at about 60° C. coincides precisely with the same range. It is not only the low gelatination temperature but also the higher enzymatic activity which during the baking process leads to the decomposition of the rye bread crumb to the extent that large voids are formed under the crust and noticeable pasty strips above the bottom. Such flour is also known as excrescent flour.

Lowering the pH value in rye dough leads to inhibiting the activity of the starch-degrading enzymes of rye flour. In rye dough, the optimum pH value influencing the enzymes is between pH 4.7 and 4.2. For setting the pH value it does not matter whether the required acid is derived from a sour dough process or whether an economically produced synthetic acid is being used.

In the colon, the roughage fraction of rye flour, including indigestible oligo-saccharides, can act as prebiotic substances. The anticarcinogenic effect of the lignants and the reduction of cholesterol together account for the advantageous effect of rye in human nutrition.

The disadvantageous of rye relative to the territorially wider dissemination of wheat products are the darker color of the crumb of the baked goods as a result of the greyish shell of the rye grains and, depending upon the degree of fineness of the flour, is rendered visible. A further disadvantage of baked rye goods is their noticeably sourer taste as a result of the formation of lactic acid and the acidification during the dough phase which are required for their baking capacity and which result from the addition of sour dough or the sour dough process. It is this taste which some consumers in those areas where rye baked goods are traditionally eaten consider to be hearty and desirable which is restricting their consumption elsewhere in the world.

At the beginning of their preparation rye doughs are already different from wheat doughs. Their color is noticeably darker and greyer and their consistency is generally described as plastic.

Since no gluten can be formed in rye dough essential differences, compared to the preparation of wheat dough, arise during the preparation of the dough.
The most important difference known between rye and wheat flour is that the pentosanes and the starch are responsible for the dough formation and for the structure of the baked products.
Aside from the starch, the binding of water in rye dough occurs primarily because of the pentosanes. The water binding capacity takes of rye dough increases at higher proportions of insoluble pentosanes.
Mixing suffices for forming the dough. There is no need for energy intensive kneading to form a protein grid.
Wheat dough can be stretched but return to their original shape. This behavior is called visco-elastic.
Rye dough is short, it maintains its given shape, it is sticky and its has plastic characteristics.

Leavening with sour dough is generally considered necessary for preparing of rye dough. Sour dough is a dough the microorganisms of which, such as bacteria and yeasts from sour dough or sour dough precursors are in an active state or may be rendered active. After adding cereal products and water, the inherent microorganisms are capable of continuous acid formation. In practice, portions of the sour dough are often used as pitching material for new sour dough.

The activity of the microorganisms in rye dough leads to an intensive formation of acid and relaxation gas. In consequence of the heat-induced metabolistic activity of the microorganisms and the gas formation during baking the pores are enlarging, the walls of the pores are being stretched further, and the volume of the bread is increasing.

Since the dough membrane of rye dough is composed of starch and pentosanes which are substantially less elastic and thus have a substantially lower gas holding capacity, rather than of gluten as in wheat, rye dough and baked rye goods do not reach the same volume as wheat products.

Aside from sour dough, the leavening of rye dough is also done by using pure acid or dough acidifiers or by a combination of sour dough and dough acidifiers.

The advantages of the sour dough process are
the intensive swelling of the flour components;
the formation of flavor precursors and flavor agents;
the formation of natural acids in balanced proportion;
control of the enzymatic decomposition of the flour components;
increased digestibility of the breads;
improved maintenance of freshness;
extended keeping properties because of retarded growth of mold.

It is assumed that the hitherto practiced lowering of the pH value to 4.7 to 4.2 or of increasing the degree of acidity to 8 to 10 by adding 35% to 45% of sour dough to doughs, relative to the amount of flour, results in reducing the activity of the rye-inherent active and abundantly present enzymes such as alpha-amylase by lowering the inactivation temperature.

Consequently, the enzyme-conditioned lowering of the viscosity of the dough, essentially the result of decomposition of the starch, is slowed down so that the lattice-forming function of the starch can be substantially maintained.

In addition to these effects of sour dough or acidifiers which according to prevailing scientific findings make it possible at all to bake with rye flour, the peptization of the rye proteins is positively affected by the limited increased degree of acidity in the dough as a result of an increase in the viscosity of the proteins which are partially capable of swelling, so that the lattice formation of the crumb structure of the baked goods and especially of bread, is stabilized during the baking process.

However, the mentioned advantages of baked rye goods are countered by problems relating to the acceptance of rye products.

The prior art is replete with variegated developmental schemes to improve such properties of rye flour in the baked product as the dark crumb color, the low volume and the sourish taste by blending wheat flour into rye flour.

If, however, the 35% to 45% proportion of sour dough in rye dough is not maintained, the prior art reports on many disadvantages. Among these are tastes which are either insipid or excessively sour, low volume of the baked goods with a dense crumb, an unstable moist crumb up to the point of forming pasty strips as well as separation of the crust from the crumb. Overall, these phenomena result in high rates of waste, especially in the case of rye bread.

It is an object of the invention to provide a baked rye product which may be technologically produced without undue complexity and which is free of a sour taste. Furthermore, the invention aims at a baked rye product of lighter crumb while maintaining the taste typical of rye products.

Compared to conventional baked rye goods, the baked rye goods with an at least 50% share of ground rye components in the ground grain products are to have a large volume, improved properties of their crumb in respect of the uniformity of its pores, improved fluffiness and chewing properties as well as a thinner and crisper crust.

In accordance with the invention the object is accomplished by a baked rye product containing at least 50% by weight of ground rye components in ground grain components, where exogenous yeast have been added to the dough and/or where prior to baking the dough has been matured at 20° C. (room conditions) for at least 12 hours for activating the native flour enzymes, with no sour dough and no dough acidifying agents being added to the dough, and that shortening is added to the dough in an amount of at least 0.5% based upon the ground grain product.

In an advantageous embodiment of the invention the pH value of the rye dough is 5.5 and the shortening added to the dough is oil. It is particularly advantageous to add a proportion of two to three percent of shortening or oil, based on the ground grain product, to the dough.

Maturing of the dough before baking to activate the native flour enzymes takes place as a function of the temperature for 3 hours at 37° C. for 12 hours at 20° C. room conditions up to 36 hours at 6 to 8° C. cooling conditions. The maturing process used is to be decided upon in accordance with the application and special conditions of the recipe. Depending upon the rules of enzyme kinetics intermediate values are implicitly disclosed within the stated limits.

A pH value of 5.5 in rye dough has been shown to be particularly advantageous. It must, however, be taken into consideration that during the baking process the pH value will slightly change in dependence of the other ingredients. Thus, an inventive baked rye product constituted by bread will in the final product have a pH value of about 6. The dough, however, has a pH value of 5.5.

Surprisingly, the concept of the invention overcomes a prejudice held by experts according to which baked rye goods can only be produced by acidification by sour dough or an acidifier.

It has been found that modern rye species are not enzymatically affected so as to require acidification for the inactivation of the enzymes decomposing starches. Exogenous yeasts are applied instead of acidification and/or maturing the dough over an extended period of time causes activation of the enzymes inherent in the flour to peptize the rye proteins.

In accordance with an advantageous embodiment of the invention the baked rye product is realized with an at least 90% by weight proportion of rye flour in the dough. In this manner direct dough processing is possible without pre-dough processing, even though advantageous embodiments of the invention can also be advantageously processed with the aid of pre-dough.

Provided the rye flour used has a degree on fineness from 75% to 80% it is possible to achieve a lighter crumb of the baked rye goods.

In accordance with a further advantageous embodiment of the invention, for its maturing enzymes which result in an improved maturing process are additionally admixed with the dough. For this purpose, hemicellulases used in an amount of from 0.005% to 0.015% based on the ground rye product are particularly advantageous. Preferably, the enzyme activity is 555 UXYLH g⁻¹.

In rye dough made fluffy by sour dough and having a conventional pH value of less than 4.7 peptization of the flour proteins is taking place in the dough which changes the conditions of solubility and swelling and which bring about the desired baking and gas-holding properties the rye dough. It has been found as a matter of surprise that adding shortening or oil of at least 2% based on the ground grain product these properties of the proteins are effective even at an inventive pH value of 5.5 in accordance with the invention or higher.

The inventive method yields a baked rye product which because of the rye ingredients possesses the nutrient physiological advantages of traditionally produced baked rye products without, however, the pronounced sour taste but approximating a baked wheat product in terms of handling and appearance.

As distinct from baked rye goods, however, the taste achieved is more aromatic which with divers other ingredients may be used for hearty products as well as for sweet products.

The invention will hereafter be explained in greater detail on the basis of several examples.

### RECIPE EXAMPLE 1

### Rye Ciabatta with Pre-Dough Process Preferably 90% Rye Flour T 815 and 10% High Protein Content Wheat Flour

For producing the pre-dough 4.5 kg of rye flour, preferably rye flour T 815 (50% of the rye flour proportion) are mixed in a spiral kneader with 22.5 g of yeast (0.5% yeast base upon the amount of rye flour in the pre-dough) and 3.6 kg of water. After a dwell time of the pre-dough at room temperature for about 14 hours, a dough is prepared from 4.5 kg of rye flour, 1 kg of high protein content wheat flour, 375.5 g of baking yeast, 220 g of salt, 400 g of olive oil and 3.6 kg of water. In accordance with the invention, the addition of oil is indispensable for improving the dough processing, raising and baking properties of rye bread. In a spiral kneader the dough is kneaded slowly for 2 minutes and rapidly for three minutes. The temperature of the dough is to be 25° C.. The dough is deposited in tubs coated with olive oil and pressed to a layer thickness of 2.5 to 3 cm. After letting the dough rest for 2 hours, flour is spread on its surface and in a manual operation the dough is turned onto a support to sever pieces of dough of desired size by lateral and longitudinal separations, spread with flour and placed on metal sheets. After rasing in a raising climate of about 32° C. and 78% relative humidity the rye ciabattas are baked at a temperature of 250 to 260° C. at a normal addition of water vapor for about 20 to 22 minutes. After a baking time of 2 minutes the flue should be drawn and 5 minutes later it should be closed again to be opened again 5 minutes before termination of baking.

### RECIPE EXAMPLE 2

### Rye Boxed Bread without Pre-Dough Processing Preferably 90% Rye Flour T 815 and 10% High Protein Content Wheat Flour

The production of the pre-dough is carried out as described in Example 1 but the dwell time of the pre-dough may be as long as 20 hours to improve the swelling processes. 4.5 kg of rye flour, 1 kg of high protein content wheat flour, 77.5 g of yeast, 300 g of olive oil, 220 g of salt, about 3.58 kg of water as well as, for improving the maturing of the dough, an enzyme compound, preferably 0.001 g of hemicellulase of a minimum activity of 555 UXYLHg⁻¹, are added to about 8.85 kg of pre-dough and slowly kneaded in a spiral kneader for 5 minutes (3 minutes slow, 2 minutes rapid). Thereafter portion of dough are weighed, elongated and placed into open forms. After rasing for from 100 to 120 minutes at a raising climate of about 32° C. and 78% relative humidity, the rye breads are baked at a constant temperature of 230° C. with strong water vapor addition for about 70 minutes. The flue should be drawn after baking for 1 minute to be closed again 10 minutes later and reopened 5 minutes before termination of baking.

### RECIPE EXAMPLE 3

### Rye-Flatbread Sticks/Rye Flatbread 90% Rye Flour, 10% Wheat Flour

At a kneading time of 6 minutes a dough is made in a spiral kneader from 9 kg of rye flour T 815 or T 997, 1 kg of wheat flour T 550, 400 g of olive oil, 250 g of yeast, 220 g of salt and 7 kg of water. After a dwell time of 20 to 24 hours at a temperature of about 6° C. elongated or round pieces of dough are formed and placed upon cloths dusted with flour. Following a raising time of 1 hour in a raising climate of about 32° C. and 78% relative humidity, the dough pieces are turned over and optionally stretched and placed upon a stackers and baked at 240° C. under the addition of strong water vapor for 35 to 40 minutes.

In accordance with the invention there is no need for adding yeast if a yeast-free batch from 20% of the amount of rye flower and water at a mixing ratio of 1:1 is subjected to spontaneous fermentation at about 30° C. over a period of about 20 hours. Further processing takes place in the manner described above.

After shaping, the pieces of dough may be filled with a hearty or sweet filling based upon dried fruits, for instance. For this purpose, for one filled flat bread the filling is distributed on one piece of dough, the margins of the dough are wiped with water and a second dough piece is placed thereon. The surface of the dough may be brushed with oil or milk. Thereafter, the pieces of dough are baked as described.

### RECIPE EXAMPLE 4

### Rye Toast Bread with Pre-Dough Processing Preferably 80% Rye Flour T 815 and 10% High Protein Content Wheat Flour

For preparing the pre-dough 4.5 kg of rye flour, preferably rye flour Type 815 (50% of the rye flour proportion), are mixed in a spiral kneader with 20 g of yeast (0.5% yeast based upon the amount of rye in the pre-dough) and 30.5 kg of water. After a dwell time of the pre-dough at room temperature for about 15 hours a dough is prepared at a dough temperature of 26° C. in a spiral kneader from 4.5. kg of rye flour, 1 kg of high protein content wheat flour, 400 g of olive oil, 180 g of yeast, 200 g of powdered milk, 200 g of sugar 200 g of salt, 100 g of pentosane-containing baking agent and about 30.5 kg of water and left to rest at room temperature for 10 minutes. Further working of the dough and shaping of the dough pieces may be done manually or by a machine. The round shaped dough pieces are pressed flat by hand and shaped into elongated pieces of dough and placed into toast bread forms. Following raising at 32° C. and 78% relative humidity the toast breads are baked at 220° C. for 35 to 40 minutes. Sweet as well as hearty flavoring components may be added to the toast bread dough to refine its taste. For instance, herbs may be added to the dough in a fresh as well as in a dried state.

### RECIPE EXAMPLE 5

### Yeast Stollen with Pre-Dough Processing Rye Flour 100%, Preferably T 815

In accordance with the invention a pre-dough is prepared from 5 kg of rye flour T 815, 25 g of yeast and 4 kg of water which is subjected to raising at room temperature for 15 to 20 hours. Separately, a fruit piece is prepared from 1.5 kg of chopped almonds, 8.3 kg of sultanas, 1.4 kg of candied lemon peel, 300 g of candied orange peel, 150 g of bitter almond flavoring, 150 g of lemon peel paste and 400 g of brandy. The fruit piece is left tp rest for 16 hours.

Stollen dough is kneaded from 18 kg of rye flour T 815, 4.6 kg of butter, 1.5 kg of sugar, 250 g of whole milk powder, 1.2 kg of yeast and the fruit piece. The dough is left to rest at room temperature for 20 minutes; after that the dough is separated according to the desired stollen size. After raising at room temperature for 20 minutes the stollen dough pieces are baked in stollen forms at an initial temperature of 200° C. decreasing to 180° C..

### RECIPE EXAMPLE 6

### Rye French Loaf (with Pre-Dough Processing) 85% Rye Flour Preferably T 815 and 15% High Protein Content Wheat Flour

The pre-dough is prepared as described in Example 1; to improve swelling, the rest period may last up to 20 hours. 4.25 kg of rye flour, 1.5 kg of high protein content wheat flour, 280 g of yeast, 400 g of olive oil, 200 g of milk powder, 200 g of sugar, 180 g of salt and about 3.35 kg of water as well as, as desired, spices to improve flavor and/or dried fruit are added to the pre-dough and kneaded in a spiral kneader for about 5 minutes. The dough of a temperature of about 26° C. is subjected to rest for 2 hours. The dough is separated into dough pieces weighing 600 g or 88 g and put into round shape and placed upside down into flour coated round baskets and left to raise in a raising climate of 32° C. and 78% relative humidity for 10 to 15 minutes and is then baked at a temperature decreasing from 250° C. to 220° C. at normal water vapor addition for 20 to 30 minutes.

To an expert the mentioned exemplary recipes disclose in usual manner the respective proportions of ingredient relative to each other and are not to limit the invention to the stated quantities.

1. A baked rye product containing ground grain products with at least 50% by weight of ground rye product made by the addition of exogenous yeast to the dough and/or maturing the dough for activating the native flour enzymes for at least 12 hours before baking with no sour dough and no dough acidifier being added to the dough, the rye dough having a pH value of more than 4.7 and containing shortening in a quantity of at least 0.5% based upon the ground grain product.

2. The baked rye product of claim 1, characterized by the fact that the shortening is added to the dough as oil at a proportion of two to three percent.

3. The baked rye product of claim 1 or 2, characterized by the fact that the baked rye product has a pH value of 6.

4. The baked rye product of one of claims 1 to 3, characterized by the fact that maturing of the dough before baking for activating the native flour enzymes is carried out as a function of the temperature for 3 hours at 37° C. over 12 hours at 20° C. room conditions up to 36 hours at 6 to 8° C. cooling conditions.

5. The baked rye product of one of claims 1 to 4, characterized by the fact that either a direct dough process or a pre-dough process is being used.

6. The baked rye product of one of claims 1 to 5, characterized b y the fact that the pH value of the baked rye product is about 6.

7. The baked rye product of one of claims 1 to 6, characterized by the fact that the rye flour has a degree of fineness of from 75% to 80.

8. The baked rye product of one of claims 1 to 7, characterized by the fact that for improving the maturing of the dough enzymes are added to the dough as hemicellulases at a proportion of 0.005% to 0.015% based upon the ground rye product.

9. A rye ciabatta in accordance with one of claims 1 to 8, characterized by the fact that for producing a pre-dough 4.5 kg of rye flour, preferably rye flour T 815 (50% of the rye flour proportion) are mixed in a spiral kneader with 22.5 g of yeast (0.5% yeast base upon the amount of rye flour in the pre-dough) and 3.6 kg of water and after a dwell time of the pre-dough at room temperature for about 14 hours, a dough is prepared from 4.5 kg of rye flour, 1 kg of high protein content wheat flour, 375.5 g of baking yeast, 220 g of salt, 400 g of olive oil and 3.6 kg of water, the addition of oil being indispensable for improving the dough processing, raising and baking properties of rye flour and that the dough is kneaded slowly for 2 minutes and rapidly for 3 minutes in a spiral kneader, that the temperature of the dough should be 25° C. and that following a dough rest period of 2 hours the dough is separated in pieces of desired size and following raising at a raising climate of 32° C. and 78% relative humidity for 10 to 15 minutes the rye ciabattas are baked at a temperature of from 250° C to 260° C. at a normal addition of water vapor for about 20 to 22 minutes.

10. A boxed bread in accordance with one of claims 1 to 8, characterized by the fact that for preparing a pre-dough 4.5 kg of rye flour T 815 (50% of the rye flour proportion) are mixed in a spiral kneader with 22.5 g of yeast (0.5% of yeast based upon the quantity of rye flour in the pre-dough) and 3.6 kg of water succeeded by a dwell time of the pre-dough of 20 hours, whereupon 4.5 kg of rye flour, 1 kg of high protein content wheat flour, 77.5 g of yeast, 300 g of olive oil, 220 g of salt, about 3.58 kg of water and as an enzyme for improving the maturing of the dough, 0.001 g of hemicellulase of a minimum activity of 555 UXYLHg⁻¹ are added to about 8.85 kg of pre-dough and are kneaded in a spiral kneader for 5 minutes (3 minutes slowly, 2 minutes rapidly) and that thereafter, following raising at a raising climate of about 32° C. and 78% relative humidity, the pieces of dough are baked at a constant temperature of 230° C. with strong addition of water vapor for about 70 minutes.

11. Rye flat bread sticks in accordance with one of claims 1 to 8, characterized by the fact that a dough is prepared by kneading in a spiral kneader for about 6 minutes 9 kg of rye flour T 815 or T 997, 1 kg of wheat flour T 550, 400 g of olive oil, 250 g of yeast, 220 g of salt and 7 kg of water, whereupon after a dwell time of 20 to 24 hours at a temperature of about 6° C. elongated or round pieces of dough are shaped and, after raising in a raising climate of about 32° C. and 78% relative humidity, are baked at 240° C. with strong addition of water vapor for 35 to 40 minutes, with no yeast being added if a yeast-free batch consisting of 20% of the rye flour and water in a 1:1 mixing ratio is subjected to spontaneous fermentation at about 30° C. for a period of from 20 hours.

12. Rye toast bread in accordance with one of claims 1 to 8, characterized by the fact that for preparing the pre-dough 4 kg of rye flour T 815 (50% of the rye flour proportion) are mixed in a spiral kneader with 20 g of yeast (0.5% of yeast based upon the quantity of rye flour in the pre-dough) and 30.5 kg of water and, following a dwell time at room temperature of the pre-dough of about 15 hours, a dough is produced at a dough temperature of about 26° C. in a spiral kneader from 4 kg of rye flour, 2 kg of high protein content wheat flour, 400 g of olive oil, 180 g of yeast, 200 g of milk powder, 200 g of sugar, 200 g of salt, 100 g of a pentosane-containing baking agent and about 30.5 kg of water which is left to rest at room temperature for 10 minutes whereupon round shaped pieces of dough are pressed flat and, following raising at 32° C. and 78% relative humidity for 60 minutes, the toast breads are baked at 220° C. for 35 to 40 minutes.

13. Rye stollen in accordance with one of claims 1 to 8, characterized by the fact that a pre-dough is prepared from 5 kg of rye flour T 815, 25 g of yeast and 4 kg of water which is left to mature for 15 to 20 hours at room temperature and that separately a fruit piece is prepared from 1.5 kg of chopped almonds, 8.3 kg of sultanas, 1.4 kg of candied lemon peel, 300 g of candied orange peel, 150 g of bitter almond flavor, 150 g of lemon peel paste and 400 g of brandy and is left to rest at room temperature for about 16 hours, and that of 18 kg of pre-dough, 5 kg of rye flour T 815, 4.6 kg of butter, 1.5 kg of sugar, 250 g of whole milk powder, 1.2 kg of yeast and the fruit piece stollen dough is kneaded and that the subsequent dough rest lasts 20 minutes at room temperature and that thereafter the dough is separated according to desired stollen size and following raising for 20 minutes at room temperature the stollen doughs are baked in stollen forms at an initial temperature of 200° C. decreasing to 180° C..

14. Rye brioche in accordance with one of claims 1 to 8, characterized by the fact that for producing a pre-dough 4.5 kg of rye flour T 815 (50% of the rye flour proportion) is kneaded in a spiral kneader with 22.5 g of yeast (0.5% yeast based upon the quantity of rye flour in the pre-dough) and 3.6 kg of water and after a rest period of the pre-dough of up to 20 hours, 4.25 kg of rye flour, 1.5 kg of high protein content wheat flour, 280 g of yeast, 400 g of olive oil, 200 g of milk powder, 200 g of sugar, 180 g of salt and about 3.35 kg of water as well as, as desired, spices and/or dried fruit are added to about 7.6 kg of pre-dough and kneaded in a spiral kneader for about 5 minutes after which the dough is subjected to rest at a temperature of about 26° C. for 2 hours, and that the dough is separated into pieces of dough of 600 g or 880 g and kneaded into round shape and thereafter left to raise for 10 to 15 minutes in a raise climate of 32° C. at 78% relative humidity and afterwards baked at 250° C. decreasing to 220° C. with normal addition of water vapor for 20 to 30 minutes.
